(19) United States
(12) Patent Application Publication
(10) Pub. No.: US 2023/0104718 A1
(43) Pub. Date: Apr. 6, 2023

(54) SYSTEM AND METHOD FOR ENHANCING MOBILE CARRIER COVERAGE

(71) Applicant: Ride Mobile, Inc., San Francisco, CA (US)

(72) Inventors: Herman Bluestein, Pataluma, CA (US); Mea Thompson, Goteborg (SE); Steven Grossmann, San Francisco, CA (US)

(21) Appl. No.: 17/961,454

(22) Filed: Oct. 6, 2022

Related U.S. Application Data
(60) Provisional application No. 63/253,011, filed on Oct. 6, 2021.

(51) Int. Cl. H04W 8/08; H04W 48/18

(52) U.S. Cl. CPC H04W 8/08; H04W 48/18

(57) ABSTRACT

Methods and apparatus are disclosed herein that enhance connectivity for mobile network operators. A mobile device continuously pings various mobile network operators to identify which mobile network operators have connectivity with the mobile device. The mobile device switches between using the mobile network operators based on the ping data. The mobile device is further able to activate this service based on entrance into, or presence in geofenced areas.

### RELATED APPLICATIONS

This application is a continuation of and claims priority to U.S. Provisional Pat. Application 63/253,011, entitled “SIMPLE AND EASY INSTALLATION OF SECOND MOBILE DATA PLAN TO INCREASE CELLULAR ACCESS,” filed Oct. 6, 2021, which is also hereby incorporated by reference in its entirety.

### TECHNICAL FIELD

Aspects of the disclosure are related to the field of mobile devices and cellular radio networks and, more particularly, to enhancing access by various mobile devices to cellular radio networks.

### BACKGROUND

Mobile devices that operate on cellular radio networks have become commonplace. In many cases these devices, which include cellular phones, smartphones, laptops, tablets, location trackers, Wi-Fi “hot spots” and vehicular systems, among others, permit data communications in addition to voice connections. This data connectivity permits a variety of actions, ranging from emergency communications to internet browsing.

While mobile device usage has become ubiquitous, cellular radio networks are built to provide coverage based on population served in a licensed service area. There are multiple licensed Mobile Network Operators (MNOs) serving major urban and suburban areas; there are fewer MNOs serving rural areas. Consequently, coverage in less dense and rural areas is not ubiquitous. MNOs large and small operate throughout the world. Most of these MNOs are continually developing their networks to increase capacity, coverage and data speeds. Nevertheless, there remain many areas of the world that have limited or no mobile network access.

Typically, a mobile phone or smartphone is served by one MNO that provides a telephone number and operates as the Primary Carrier or primary MNO for both voice and data. Other devices, such as laptops, tablets, trackers, Wi-Fi “hot spots” and vehicular systems, are also connected to a single, primary MNO for data for that device.

Thus, when a mobile subscriber is in an area with access to cellular service, but not that of their primary MNO, the mobile end user will be unable to obtain access to voice or data services.. Roaming enables a mobile subscriber to automatically make and receive voice calls, send and receive data, or access other services when travelling outside the geographical coverage area of their Primary MNO, by means of using a visited network. This typically occurs when the user is traveling internationally. However, within their own country, large MNOs treat coverage as a service differentiator, and do not typically permit their competitors’ end users to roam on competing MNO’s network. In this case, the user will have limited or no access to other cellular networks, even where a radio signal is available. Even where network roaming is available, roaming services are typically expensive, and not entirely effective.

This issue is particularly obvious to users that travel to more remote areas of the world for adventure, outdoor recreation, and other activities outside more dense urban and developed areas. These remote areas are more likely to have limited cellular radio network access and/or a limited number of MNOs. In some cases, even access to this subset of MNOs is inconsistent. These users in remote areas are also frequently involved in dangerous outdoor activities, such as hiking, rock climbing, backcountry skiing, and overlanding, etc. With outdoor adventure comes risk, increasing the need for emergency communication and other data access.

### OVERVIEW

A method and apparatus for enhancing cellular radio network access of a mobile device is disclosed herein. The mobile device is registered with a primary Mobile Network Operator. The method includes registering the mobile device with a secondary access plan service. The mobile device determines that it is located in a geo-fenced area. The secondary access plan service is activated in response to this determination. The mobile device then sends requests to a set of Mobile Network Operators and receives at least one response from a first Mobile Network Operators that is not the primary Mobile Network Operator. The mobile device then obtains cellular radio network access through the secondary access plan service using the first Mobile Network Operator.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment in an example implementation.

FIGS. 2A-2D illustrate example network coverage in an implementation.

FIG. 3 illustrates example network coverage in an implementation.

FIG. 4 illustrates a registration process in an implementation.

FIG. 5 illustrates an access enhancement process in an implementation.

FIG. 6 illustrates example network coverage based on ping responses in an implementation.

FIG. 7 illustrates an operational sequence in an implementation.

FIG. 8 illustrates coverage in an implementation.

FIG. 9 illustrates a geofencing process in an implementation.

FIG. 10 illustrates a computing system suitable for implementing the various operational environments, architectures, processes, scenarios, and sequences discussed below with respect to the Figures.

### DETAILED DESCRIPTION

Technology disclosed herein relates to systems and methods for enhancing cellular network coverage for extending the range of mobile devices. In particular, systems and methods are presented to allow a mobile device to identify an MNO with coverage for the device, and switch to using that MNO. While discussion herein discusses connectivity with MNOs, which can provide both audio and data connections, it should be understood that the systems and methods described herein apply to both audio and data services along with data services independent of audio and/or audio services independent of data.

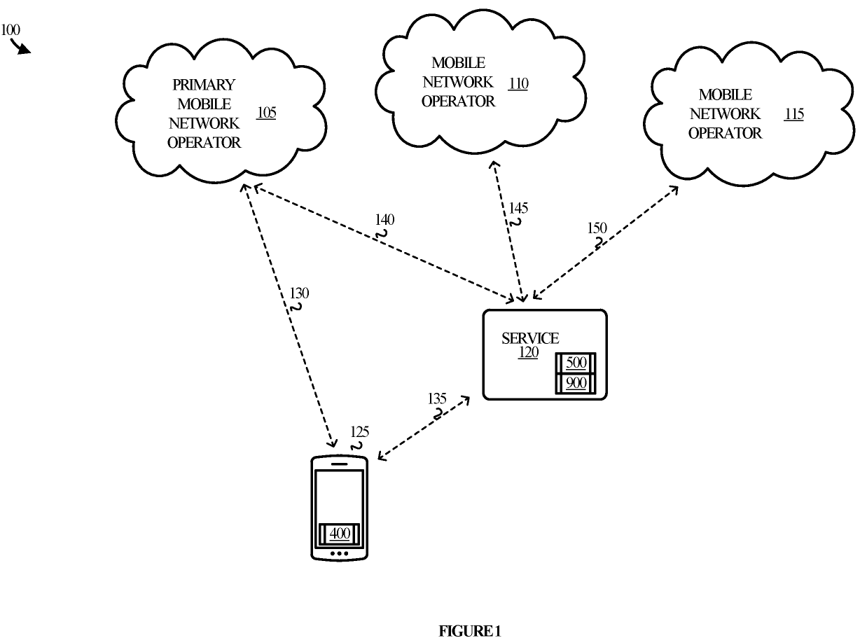

Looking at FIG. 1, an example operational environment 100 is shown. Mobile device 125 can be any mobile device. Mobile device 125 may contain a cellular radio and be operable on a cellular network. Mobile device 125 may be operable for audio communications, such as a cellular telephone, and may also be operable for data communications. Mobile device 125 may be handheld, portable or stationary, and may be operable on battery power or some other power source. Mobile device 125 may be, for example, a cellular phone, a smart phone, a tablet computer, a laptop computer, a pager, a gaming device, a desktop computer, a smart watch, a camera, a smart television or video player, or some other mobile device.

Mobile device 125 is in communication with primary Mobile Network Operator (primary MNO) 105. This communication may occur through any of a variety of communication protocols, such as Time division Multiple Access (TDMA), Universal Mobile Telecommunications System (UMTS), Frequency Division Multiplexing (FDM), Time Division Multiplexing (TDM), Code Division Multiplexing (CDM), Wireless Local Loop (WLL), General Packet Radio Services (GPRS), Enhanced Data Rates for GSM Evolution (EDGE), Universal Mobile Telecommunications System (UMTS), IP over CCN (IPoC), Long Term Evolution (LTE), LTE - Evolved Packet Core (LTE-EPC), among others. Some of these protocols are combined in standards, such as Global System for Mobile Communications (GSM), Code Division Multiple Access (CDMA) or Integrated Digital Enhanced Network (iDEN).

In an implementation, primary MNO requires registration of mobile device 125. Registration may occur, for example, by registering a mobile device identification number for mobile device 125 with primary MNO 105. The mobile device identification number may be, for example, an Electronic Serial Number (ESN), a Mobile Equipment ID (MEID), or an International Mobile Equipment Identity (IMEI).

Additionally, mobile device 125 may contain a key that supports the registration, such as a Subscriber Identity Module (SIM) card. An example SIM card contains an international mobile subscriber identity (IMSI) and a related key, for example. A SIM card may come in a variety of physical formats or may be purely electronic.

Mobile device is also capable of carrying out registration process 400, which will be described in detail below.

Once mobile device 125 is registered with primary MNO 105, mobile device can communicate with primary MNO 105. This communication can facilitate communications with other mobile devices or with other networked servers, such as through the internet. Primary MNO 105 may provide services, such as audio communication and/or data services for a fee according to a contract with a user of mobile device 125. Typically, primary MNO 105 has an incentive to provide as much of the communications services to mobile device 125 as possible. This may be due in part to the desire of primary MNO 105 to receives fees for services, and in part to the desire to ensure that mobile device 125 does not continue to use a different MNO after switching. Regardless, in certain locations, mobile device 125 may have little to no access to primary MNO 105, such as due to lack of network coverage, and mobile device 125 may have a desire to communicate through a different MNO, such as MNO 110 or MNO 115. While three MNOs are shown, it should be noted that any number of MNOs greater than 1 may be used in the system and methods described herein.

MNO 110 and MNO 115 may use the same standard to communicate as primary MNO 105. For example, primary MNO 105 and MNO 110 may both be based on the GSM standard. Mobile device 125 may also be based on the GSM standard. In an implementation, MNO 115 may be based on the CDMA standard instead. Mobile device 125 may be configured to communicate according to only a single standard or may be configured to communicate over multiple standards. For example, in an implementation, mobile device 125 is configured to communicate according to the GSM standard and will be able to communicate directly only with primary MNO 105 and MNO 110. In an alternate implementation, mobile device 125 is configured to operate according to either the GSM standard or the CDMA standard and is capable of communicating with any of primary MNO 105, MNO 110 and MNO 115.

Secondary access plan service 120 is a remote service capable of communicating with mobile device 125. Secondary access plan service 120 may be hosted on a server or virtual server comprising memory and processing hardware. Some of the activities that will be described herein as part of secondary access plan service 120 may take place on mobile device 125, such as through an app on a mobile device 125. Secondary access plan service 120 is capable of executing access enhancement process 500 and geofencing process 900, which are discussed in detail below.

Secondary access plan service 120 is shown in communication with mobile device 125 through communication path 135, and with primary MNO 105, MNO 110 and MNO 115 through communication paths 140, 145 and 150, respectively. While communication paths 140, 145 and 150 are shown as connecting with secondary access plan service 120, in an implementation, communication paths 140, 145 and 150 connect directly to mobile device 125, with secondary access plan service 120 acting to direct mobile device 125 on which communication path to use, rather than acting as an intermediary. This will be described in more detail below.

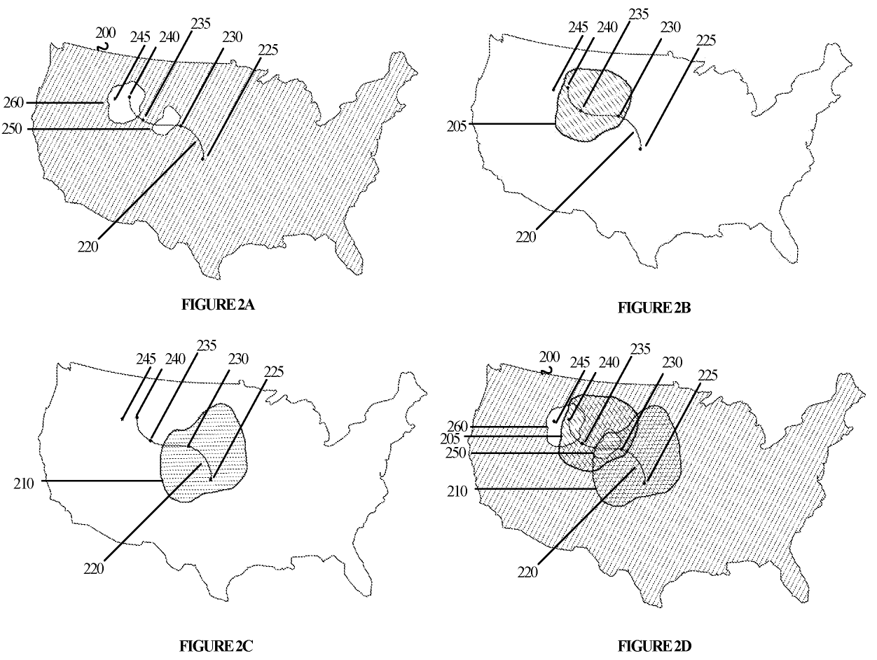

FIG. 2 shows an example representation of the coverage of primary MNO 105. Geographical outline 200 outlines a geographical area. In FIG. 2A, this outline represents the border of the United States of America. Geographical outline 200 could be the border of a different continent, country, state, province, or the like, or could simply be an arbitrary outline, such as a square or circle representing an area.

Most of the area within geographical outline 200 is shown with hatching. This represents the area in which communication with primary MNO 105 is feasible. FIG. 2A is merely a representation. In an implementation, FIG. 2A may be a map provided by primary MNO 105 which shows the areas in which a signal from primary MNO 105 is available for an average mobile device. In another implementation, FIG. 2A may represent the availability of a signal from primary MNO 105 for a particular mobile device, such as mobile device 125. Dead spot 250 and dead spot 260 represent areas in which communication with primary MNO 105 is not available. In an implementation, dead spots 250 and 260 represent areas in which no signal from primary MNO 105 is available. In an alternate implementation, dead spots 250 and 260 represent areas in which the signal from primary MNO 105 falls below a threshold. Regardless of the particulars of FIG. 2A, it is used here as a tool to demonstrate the system and methods described herein.

Path 220 is used to represent a path through the geographical area represented within geographical outline 200. Path 220 may correspond to a path along a road, highway, railroad, river or the like, or may simply be a random path which may be traversed. Path 220 is used to represent an actual geographical path which a user of mobile device 125 may traverse. For example, a user may begin at point 225, traverse through points 230 and 235, and finish at point 240.

This user travelling this route from point 225 to point 240, would lose a connection to primary MNO 105 two separate times. It should be understood that this is merely a representation, and in actual travel, such a user would likely lose connection with primary MNO many more times.

Point 245 is used to represent a single physical location. A user at point 245 as shown in FIG. 2A would have no connectivity with primary MNO 125.

FIGS. 2B and 2C show representations of coverage of MNO 110 and MNO 115, respectively. Again, it should be understood that the actual layout of FIGS. 2B and 2C is merely exemplary, and coverage may be different than shown and still fall within the boundaries of this description. In FIGS. 2B and 2C, MNO 110 and MNO 115 have limited coverage areas. Unlike primary MNO 105, MNO 110 and MNO 115 only cover the area within coverage areas 205 and 210, respectively.

The user travelling from point 225 to point 240 in FIG. 2B would have no connectivity to MNO 110 until the user has nearly reached point 230, after which coverage would be available. The same hypothetical user, according to FIG. 2C would have connectivity to MNO 115 at the beginning of the trip, but shortly after passing through point 230 would lose connectivity.

FIG. 2D overlays each of FIGS. 2A-2C together. FIG. 2D shows that the hypothetical user travelling from point 225 to point 240 will have connectivity to both primary MNO 105 and MNO 115 initially and will gain connectivity to MNO 110 just before point 230. Thus, at point 230, the user will have connectivity to each of primary MNO 105, MNO 110 and MNO 115. Between points 230 and 235, the user will lose connectivity to primary MNO 105 and MNO 115. By point 235, the user regains connectivity to primary MNO 105, but loses that connectivity again before point 240. At point 240, the user only has connectivity with MNO 110. At point 245, the user has no connectivity to any of primary MNO 105, MNO 110 and MNO 115.

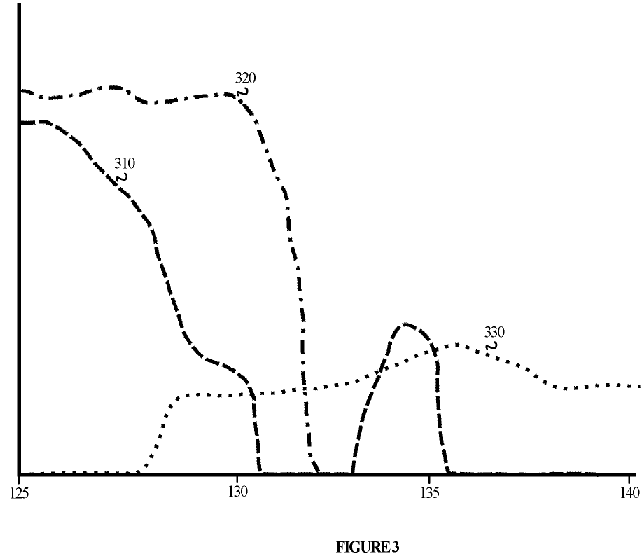

FIG. 3 shows a representation of the connectivity for the user as described above. Note that FIG. 3 further shows signal strength available from each of primary MNO 105 (310), MNO 110 (320) and MNO 115 (330). In an implementation, the data available may not provide a signal strength, and may only indicate whether a signal is available from each of primary MNO 105, MNO 110 and MNO 115.

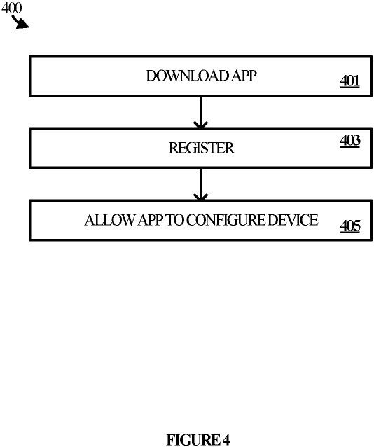

FIG. 4 shows the steps of a registration process for mobile device 125. In step 401, the mobile device downloads an application that will facilitate communication with secondary access plan service 120. In an implementation, the application is downloaded by the user finding and downloading the application from an app store typical for the mobile device 125. Alternatively, the application may be presented to the user for download, or automatically downloaded. This could occur through a link in advertising materials, a Quick Response (QR) code or some other machine-readable code, or through an automated process initialized by running a program or inserting a SIM card, for example.

In step 403, the mobile device 125 is registered with secondary access plan service 120. The registration may include registration of a user of the mobile device, and/or selection of a service plan for mobile device 125. Registration may also include actions on mobile device 125, such as insertion of a SIM card, incorporation of an eSIM, or some other provisioning.

In step 405, mobile device 405 is configured by the application. For example, mobile device 125 may have a variety of settings that affect or allow switching between cellular providers, such as primary MNO 105, MNO 110, MNO 115 or secondary access plan service 120. By way of example, mobile device 125 may have a setting that allows changing cellular networks with or without notification to the user. Each mobile device can have various settings. In an implementation the configuration of these settings by the application first identifies what type of mobile device is being configured, and then uses a predetermined script to modify the settings that allow communication with and/or control by secondary access plan service 120.

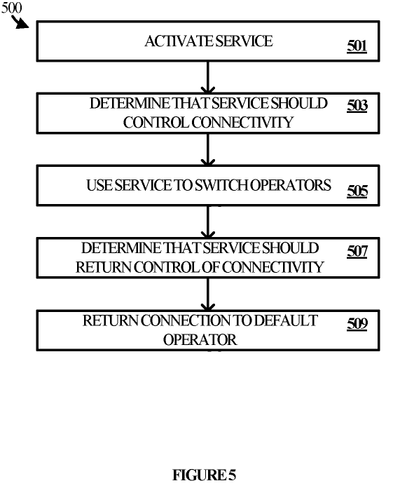

FIG. 5 depicts an access enhancement process. In step 501, service is activated. This service can be secondary access plan service 120. Activation may be accomplished through the registration process depicted in FIG. 4. In an implementation, activation further includes selecting that secondary access plan service 120 should be enabled, such as through a setting on mobile device 125, through a link, QR code or some other code, or through a pop-up notification and/or request for approval on mobile device 125.

Secondary access plan service 120 determines that secondary access service plan should control connectivity for mobile device 125 (503). This determination may take place on mobile user device 125, such as in the application loaded on mobile device 125 or may occur remotely at secondary access service plan 120. In an implementation, the determination occurs when connectivity with primary MNO 105 is interrupted. In another implementation, when secondary access plan service 120 is activated, it begins actively monitoring connectivity of primary MNO 105, MNO 110 and MNO 115, and determines that secondary access service plan 120 should control connectivity. In an implementation, in order for secondary access plan service 120 to take over control of connectivity, mobile device 125 switches networks in the mobile device settings. For example, where mobile device 125 was using primary MNO 105 as its cellular provider, after the change in control, mobile device 125 uses secondary access plan service 120 as its cellular provider. This may be accomplished by switching to using the second SIM card or eSIM that was registered with secondary access plan service 120 in the mobile device 125.

This active monitoring will be discussed with regard to step 505. In step 505, Secondary access plan service 120 actively switches between MNOs to enhance connectivity. In an implementation, this active switching occurs through secondary access plan service 120, such that mobile device 125 remains connected to secondary access plan service 120, and secondary access plan service 120 communicates with each of the MNOs as needed. In another implementation, secondary access plan service 120 controls mobile device 125, and mobile device 125 communicates directly with each of the MNOs as directed by secondary access plan service 120. Regardless of the communication scheme, secondary access plan service 120 identifies which MNO is available to provide service to mobile device 125. In an implementation, this is done by pinging the MNOs from mobile device 125. While the term “ping” is used here, in an implementation the “ping” could request information about the connectivity for the MNO in addition to merely requesting an echo reply. By analyzing the ping responses, secondary access plan service 120 can determine which MNOs can provide connectivity to mobile device 125. This pinging can occur, for example, when mobile device loses connectivity with the current MNO providing access. In an embodiment, mobile device 125 consistently pings each of the MNO, such as primary MNO 105, MNO 110 and MNO 115, providing a consistent source of connectivity data for secondary access plan service 120.

These pings may be sent on a consistent time basis, such as every minute, or every 5 minutes, or they may be sent based on geography, such as pings sent every 50 ft, or every tenth of a mile. In an implementation, the pings may be sent using some combination of time and geography, such as pings sent every 10 seconds while moving above a speed threshold, and every 5 minutes when moving below that threshold. One of ordinary skill in the art will understand that many other scenarios exist that could determine how to send out pings. Further, the pings may be sent to only a portion of the available MNOs. For example, in location 225, secondary access plan service 120 may know that the average device will not have connectivity with MNO 110, so secondary access plan service 120 may only send pings out to primary MNO 105 and MNO 115. secondary access plan service 120 may be configured to consider various thresholds to determine what pings should be sent out.

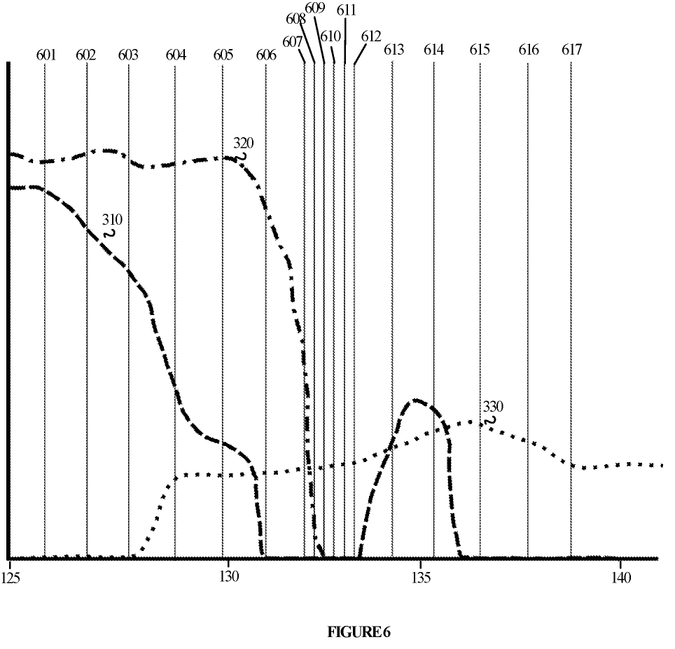

FIG. 6 shows an example of ping data returned from primary MNO 105, MNO 110 and MNO 115 to mobile device 125 as it travels from point 225 to point 240 according to an implementation. Ping data is sent out at a consistent time interval. Ping responses to pings 601 to 607 are received as mobile device 125 is moving at a relatively constant speed along the route. This could occur, for example, as a user is driving in a car. Somewhere between point 230 and point 235, the user exits the car and begins to walk. Because the ping data is collected at a consistent time interval, responses to pings 608-612 are much closer together geographically. At that point, the user begins driving again, and the ping data separates geographically again. In this scenario, mobile device may retain connectivity to primary MNO 105 through ping 605. At ping 606, according to an implementation, mobile device 125 fails to receive a response to the ping sent to primary MNO 105. Secondary access plan service 120 then decides to switch providers to use MNO 110. This decision is based on the response received by mobile device 125 indicating that connectivity is available with MNO 110, as well as knowledge by secondary access plan service 120 that, in the direction mobile device 125 is travelling, MNO 115 will soon not have connectivity.

It should be understood that secondary access plan service 120 could choose to switch to MNO 115 instead of MNO 110 at ping 606, and that the decision could be based on a variety of factors, including strength of signal, cost, continuity, location predictions, among others.

Secondary access plan service 120 can use the ping response data to determine which MNO should be used to provide connectivity to mobile user device 125. In an implementation, secondary access plan service 120 uses the strongest signal response from the ping data to determine what MNO to utilize. In another implementation, secondary access plan service 120 uses a more complex algorithm to determine what MNO to use. For example, preference may be given to the currently active MNO, or preference may be given to a particular MNO that has lower rates or typically better connectivity. Latency information received from the ping response may also be used to determine which MNO to use.

Turning back to FIG. 5, in step 507, secondary access plan service 120 determines that control of connectivity should be returned to primary MNO 105. This determination can be based on many factors. In an implementation, once connectivity with primary MNO 105 is again confirmed, secondary access plan service 120 returns control to primary MNO 105 (509). In an implementation, this return of control occurs as mobile device 125 switches back to using primary MNO 105 (corresponding to the main SIM card or eSIM) as the cellular provider.

According to an implementation, rather than switching back to primary MNO 105 as soon as connectivity with primary MNO 105 is confirmed, secondary access plan service 120 waits until a number of consecutive ping responses have shown connectivity with primary MNO 105. In this way, continuity can be preserved. For example, secondary access plan service 120 may require 3 consecutive positive ping responses showing connectivity with primary MNO 105 before secondary access plan service 120 determines that control should be returned to primary MNO 105. In another implementation, this same functionality may be controlled on mobile device 125, such as by the downloaded application or by mobile device 125 settings or software. Looking at FIG. 6, at ping 613, secondary access plan service 120 is able to first identify that primary MNO 105 has connectivity with mobile device 125. Ping 614 confirms this connectivity. Ping 615, however fails to show connectivity again. Thus, if secondary access plan service 120 required 3 consecutive positive ping responses, secondary access plan service 120 would not determine that control should be returned to primary MNO 105. In fact, secondary access plan service 120 would not determine that control should be returned to primary MNO 105 during the trip to point 240.

It should also be recognized that at some locations, none of the available MNOs will respond to ping messages. For example, at point 245, none of the DMOs have connectivity with mobile device 125. In this case, secondary access plan service 120, in conjunction with the application on mobile device 125 can take some other action. For example, mobile device 125 may display a notification indicating that cellular service is not available. In another example, mobile device 125 could activate a satellite phone, or some other communication device.

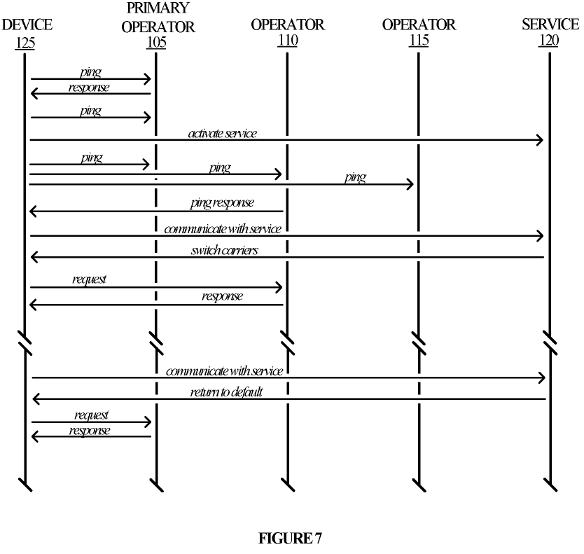

FIG. 7 illustrates coverage enhancement in an implementation. Mobile device 125 has already downloaded the application and registered with secondary access plan service 120. Mobile device 125 sends a ping message to primary MNO 105 requesting an echo response. primary MNO 105 returns an echo response to the ping request. This ping and response interplay is shown only once but may occur more than one time. Eventually, a ping request is sent by mobile device 125 and no response is received from primary MNO 105. In alternate implementations, secondary access plan service 120 or mobile device may determine to activate secondary access plan service 120 through some other method, such as failure of communications through primary MNO 105.

After this indication that primary MNO 105 has no current connectivity for mobile device 125, mobile device sends a message to secondary access plan service 120 to activate secondary access plan service 120. In an alternate implementation, this activation may occur entirely within mobile device 125. After secondary access plan service 120 is activated, mobile device 125 sends ping requests to primary MNO 105, MNO 110 and MNO 115. A response to the ping request is received from MNO 110. Mobile device 125 communicates with secondary access plan service 120 to provide the ping response data, and secondary access plan service 120 responds with a command to switch to MNO 110. After mobile device has switched to communicate through MNO 110, mobile device sends a request to MNO 110 and receives a response from MNO 110. As mentioned above, it should be understood that this communication, and switching MNOs may occur at secondary access plan service 120 or may occur on the mobile device 125. Consequently, further communication through MNO 110 may occur directly from mobile device 125 or through secondary access plan service 120 as an intermediary.

After normal communication using MNO 110, eventually, mobile device 125 communicates to secondary access plan service 120. This communication may be an indication that is it time to revert to primary MNO 105, based on one or more of a variety of reasons, or it may be a communication of data that allows secondary access plan service 120 to determine that it is time to revert to primary MNO 105. After this determination, secondary access plan service 120 returns control to primary MNO 105, and communication proceeds as usual (with request and response) through primary MNO 105.

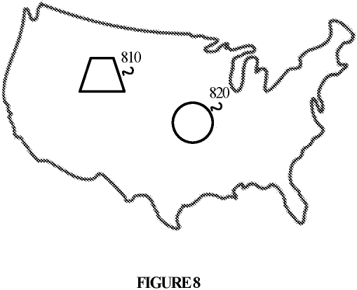

FIG. 8 illustrates examples of geofencing at a high level. Area 820 is shown as a geofenced area around a single point. Area 820 is shown as a circle, because any location within a certain distance of the center point of area 820 falls within area 820. Area 810 is bounded by particular geographic perimeter. Area 820 is shown as a trapezoid, but Area 810 could be made to cover any shape. Unlike area 820, area 810 is defined by its perimeter.

According to an implementation, mobile device 125 has hardware and/or software which allows mobile device 125 to identify its own geographical location. This includes global positioning system (GPS) hardware and software, among others. Mobile device 125 can work with secondary access plan service 120, as needed, to identify geofenced areas relevant to secondary access plan service 120. By way of example, such areas may include national and state parks, popular outdoor destinations, rivers, mountains or mountain ranges, trailer or RV parks, campgrounds, or other areas. In an implementation, areas that routinely have outdoor enthusiasts or other users that frequently benefit the enhanced coverage system and methods described herein can be geofenced by secondary access plan service 120. When mobile device 125 or secondary access plan service 120 determines that mobile device is within a geofenced area, such as area 810, mobile device 125 can activate secondary access plan service 120.

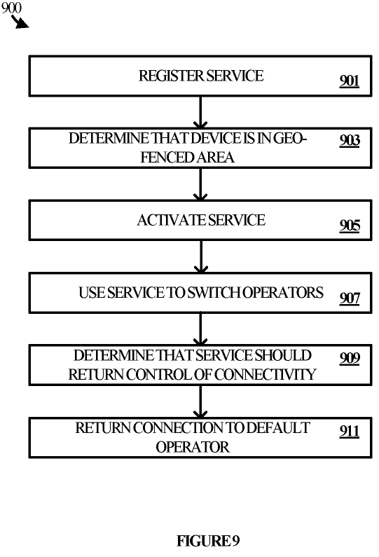

FIG. 9 illustrates a method of enhancing connectivity of mobile device 125 using geofencing. In step 901, the mobile device downloads an application that will facilitate communication with secondary access plan service 120. The application may also be configured to interact with the hardware and software of mobile device 125 to identify when mobile device 125 has entered a geofenced area. In an implementation, the application is downloaded by the user finding and downloading the application from an app store typical for the mobile device 125. Alternatively, the application may be presented to the user for download, or automatically downloaded. This could occur through a link in advertising materials, a Quick Response (QR) code or some other machine-readable code, or through an automated process initialized by running a program or inserting a SIM card, for example.

In step 903, mobile device or secondary access plan service 120 determine that mobile device 125 is in a geofenced area, such as area 810. In an implementation, this determination includes more than simply identifying whether the mobile device 125 is currently in a geofenced area. For example, mobile device 125 or secondary access plan service 120 may wait until mobile device has indicated presence in a geofenced area for a certain amount of time, or a certain number of times continuously. Alternatively, mobile device 125 or secondary access plan service 120 may factor predictive analysis into the determination. For instance, mobile device 125 or secondary access plan service 120 may determine that mobile device 125 is travelling towards and likely to enter a geofenced area, or that mobile device 125 is likely to stay within the geofenced area.

In response to determining that mobile device is in (or likely to enter, or likely to stay in, etc.) a geofenced area, mobile device 125 and/or secondary access plan service 120 then activate secondary access plan service 120 (905). While this activation may be as discussed above, it also may involve additional steps. For example, the activation may not be automatic. Mobile device 125 may show a notification to a user that the mobile device has entered an area that would benefit from activating secondary access plan service 120. The user may then choose to activate the secondary access plan service 120 or not. Alternatively, mobile device 125 may automatically activate secondary access plan service 120 and show a notification to a user that secondary access plan service 120 has been activated.

After activation, mobile device 125 and/or secondary access plan service 120 can switch MNOs as described above (907). In addition to the description above on when to revert to primary MNO 105 for service, mobile device 125 and/or secondary access plan service 120 may also consider whether mobile device has exited or is predicted to exit the geofenced area. Thus, when mobile device 125 leaves a geofenced area, such as area 810, mobile device 125 and/or secondary access plan service 120 may determine to revert control to primary MNO 105 (909). Alternatively, when mobile device 125 leaves, or is expected to leave a geofenced area, mobile device 125 and/or secondary access plan service 120 may simply return to the analysis of MNOs as discussed above to determine when to revert to primary MNO 105. Mobile Device may also display a notification to a user, with or without an approval request, indicating that the mobile device is leaving the geofenced area. After this determination, secondary access plan service 120 returns control over connectivity to primary MNO 105.

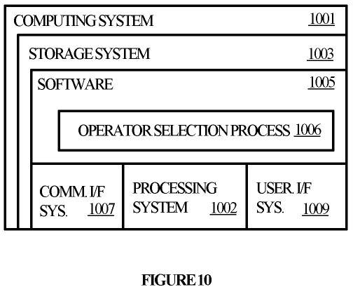

FIG. 10 illustrates computing system 1001 that is representative of any system or collection of systems in which the various processes, programs, services, and scenarios disclosed herein may be implemented. Examples of computing system 1001 include, but are not limited to, server computers, routers, web servers, cloud computing platforms, and data center equipment, as well as any other type of physical or virtual server machine, physical or virtual router, container, and any variation or combination thereof.

Computing system 1001 may be implemented as a single apparatus, system, or device or may be implemented in a distributed manner as multiple apparatuses, systems, or devices. Computing system 1001 includes, but is not limited to, processing system 1002, storage system 1003, software 1005, communication interface system 1007, and user interface system 1009 (optional). Processing system 1002 is operatively coupled with storage system 1003, communication interface system 1007, and user interface system 1009.

Processing system 1002 loads and executes software 1005 from storage system 1003. Software 1005 includes and implements operator selection process 1006, which is representative of the security testing process discussed with respect to the preceding Figures. When executed by processing system 1002 to provide an operator selection process, software 1005 directs processing system 1002 to operate as described herein for at least the various processes, operational scenarios, and sequences discussed in the foregoing implementations. Computing system 1001 may optionally include additional devices, features, or functionality not discussed for purposes of brevity.

Referring still to FIG. 10, processing system 1002 may comprise a micro-processor and other circuitry that retrieves and executes software 1005 from storage system 1003. Processing system 1002 may be implemented within a single processing device but may also be distributed across multiple processing devices or sub-systems that cooperate in executing program instructions. Examples of processing system 1002 include general purpose central processing units, graphical processing units, application specific processors, and logic devices, as well as any other type of processing device, combinations, or variations thereof.

Storage system 1003 may comprise any computer readable storage media readable by processing system 1002 and capable of storing software 1005. Storage system 1003 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal or a carrier wave.

In addition to computer readable storage media, in some implementations storage system 1003 may also include computer readable communication media over which at least some of software 1005 may be communicated internally or externally. Storage system 1003 may be implemented as a single storage device but may also be implemented across multiple storage devices or sub-systems co-located or distributed relative to each other. Storage system 1003 may comprise additional elements, such as a controller, capable of communicating with processing system 1002 or possibly other systems.

Software 1005 (including operator selection process 1006) may be implemented in program instructions and among other functions may, when executed by processing system 1002, direct processing system 1002 to operate as described with respect to the various operational scenarios, sequences, and processes illustrated herein. For example, software 1005 may include program instructions for implementing an operator selection process to enhance carrier coverage as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1005 may include additional processes, programs, or components, such as operating system software, virtualization software, or other application software. Software 1005 may also comprise firmware or some other form of machine-readable processing instructions executable by processing system 1002.

In general, software 1005 may, when loaded into processing system 1002 and executed, transform a suitable apparatus, system, or device (of which computing system 1001 is representative) overall from a general-purpose computing system into a special-purpose computing system customized to provide packet redirection. Indeed, encoding software 1005 on storage system 1003 may transform the physical structure of storage system 1003. The specific transformation of the physical structure may depend on numerous factors in different implementations of this description. Examples of such factors may include, but are not limited to, the technology used to implement the storage media of storage system 1003 and whether the computer-storage media are characterized as primary or secondary storage, as well as other factors.

For example, if the computer readable storage media are implemented as semiconductor-based memory, software 1005 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1007 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 1001 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in many ways to form multiple embodiments. As a result, the invention is not limited to the specific embodiments described above, but only by the claims and their equivalents.

What is claimed is:

1. A method of enhancing cellular radio network access of a mobile device, comprising:
registering the mobile device with a secondary access plan service, the mobile device also registered with a primary Mobile Network Operator;
determining that the mobile device is located in a geo-fenced area;
activating the secondary access plan service in response, at least in part, to determining that the mobile device is located in a geo-fenced area;
sending requests to a set of Mobile Network Operators;
receiving at least one response from a first Mobile Network Operator from the set of Mobile Network Operators, where the first Mobile Network Operator is not the primary Mobile Network Operator; and
obtaining cellular radio network access through the secondary access plan service utilizing the first Mobile Network Operator.

2. The method of claim 1, further comprising:
sending second requests to the set of Mobile Network Operators;
receiving at least one response from the primary Mobile Network Operator; and
deactivating the secondary access plan service in response, at least in part, to receiving at least one response from the primary Mobile Network Operator.

3. The method of claim 1, further comprising:
sending periodic requests to the set of Mobile Network Operators;
tracking a number of consecutive responses that are received from the primary Mobile Network Operator; and
deactivating the secondary access plan service when the number of consecutive responses exceeds a threshold.

4. The method of claim 1, wherein determining that the mobile device is located in the geo-fenced area further includes determining that the mobile device has remained in the geo-fenced area for an amount of time greater than a threshold.

5. The method of claim 1, wherein registering the mobile device with a secondary access plan service comprises registering an eSIM with mobile device.

6. The method of claim 1, wherein obtaining the cellular radio network access through the secondary access plan service utilizing the first Mobile Network Operator comprises obtaining cellular data network access.

7. The method of claim 1, wherein the geo-fenced area corresponds to one of a national park, a state park, a campground, and an RV park.

8. A mobile device with an application loaded thereon, configured to:
register the mobile device with a secondary access plan service, the mobile device also registered with a primary Mobile Network Operator;
determine that the mobile device is located in a geo-fenced area;
activate the secondary access plan service in response, at least in part, to determining that the mobile device is located in a geo-fenced area;
send requests to a set of Mobile Network Operators;
receive at least one response from a first Mobile Network Operator from the set of Mobile Network Operators, where the first Mobile Network Operator is not the primary Mobile Network Operator; and
obtain cellular radio network access through the secondary access plan service utilizing the first Mobile Network Operator.

9. The mobile device of claim 8, further configured to:
send second requests to the set of Mobile Network Operators;
receive at least one response from the primary Mobile Network Operator; and
deactivate the secondary access plan service in response, at least in part, to receiving at least one response from the primary Mobile Network Operator.

10. The mobile device of claim 1, further configured to:
send periodic requests to the set of Mobile Network Operators;
track a number of consecutive responses that are received from the primary Mobile Network Operator; and
deactivate the secondary access plan service when the number of consecutive responses exceeds a threshold.

11. The mobile device of claim 1, wherein determining that the mobile device is located in the geo-fenced area further includes determining that the mobile device has remained in the geo-fenced area for an amount of time greater than a threshold.

12. The mobile device of claim 1, wherein registering the mobile device with a secondary access plan service comprises registering an eSIM with mobile device.

13. The mobile device of claim 1, wherein obtaining the cellular radio network access through the secondary access plan service utilizing the first Mobile Network Operator comprises obtaining cellular data network access.

14. The mobile device of claim 1, wherein the geo-fenced area corresponds to one of a national park, a state park, a campground, and an RV park.

15. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
register the mobile device with a secondary access plan service, the mobile device also registered with a primary Mobile Network Operator;
determine that the mobile device is located in a geo-fenced area;
activate the secondary access plan service in response, at least in part, to determining that the mobile device is located in a geo-fenced area;
send requests to a set of Mobile Network Operators;
receive at least one response from a first Mobile Network Operator from the set of Mobile Network Operators, where the first Mobile Network Operator is not the primary Mobile Network Operator; and
obtain cellular radio network access through the secondary access plan service utilizing the first Mobile Network Operator.

16. The computing apparatus of claim 15, wherein the program instructions further direct the computing apparatus to:
send second requests to the set of Mobile Network Operators;
receive at least one response from the primary Mobile Network Operator; and
deactivate the secondary access plan service in response, at least in part, to receiving at least one response from the primary Mobile Network Operator.

17. The computing apparatus of claim 15, wherein the program instructions further direct the computing apparatus to:
send periodic requests to the set of Mobile Network Operators;
track a number of consecutive responses that are received from the primary Mobile Network Operator; and
deactivate the secondary access plan service when the number of consecutive responses exceeds a threshold.

18. The computing apparatus of claim 15, wherein registering the mobile device with a secondary access plan service comprises registering an eSIM with mobile device.

19. The computing apparatus of claim 15, wherein obtaining the cellular radio network access through the secondary access plan service utilizing the first Mobile Network Operator comprises obtaining cellular data network access.

20. The computing apparatus of claim 15, wherein the geo-fenced area corresponds to one of a national park, a state park, a campground, and an RV park.
